(19) United States
(12) Patent Application Publication
(10) Pub. No.: US 2019/0135575 A1
(43) Pub. Date: May 9, 2019

(54) Motion Drive System for Controlling a Rolling Ring Drive

(71) Applicant: JOACHIM UHING GMBH & CO. KG, Mielkendorf (DE)

(72) Inventor: Marvin Kuhlmann-Kaufhold, Kronshagen (DE)

(21) Appl. No.: 16/096,432

(22) PCT Filed: Mar. 31, 2017
(86) PCT No.: PCT/EP2017/057777

§ 371 Date: Oct. 25, 2018

(30) Foreign Application Priority Data
Apr. 1, 2016 (DE) 20 2016 002 001.4

(51) Int. Cl. B65H 54/28; F16H 19/02

(52) U.S. Cl. CPC B65H 54/2866; F16H 19/025

(57) ABSTRACT

A motion drive system for controlling a rolling ring drive which comprises the steps of:
determining the dead centre of the rolling rings to provide the operational mid-point for a stepper motor when reversing the rolling rings;
establishing a start point;
setting a first reversal point and a second point for reversal of the rolling ring drive which are defined in relation to the start point;
determining the speed of travel of the rolling ring drive in dependence upon the material to be wound and/or the speed of the coiling;
determining an end point for coiling depending upon the depth of coiling required or the amount of material to be coiled;
from these, the pitch of the rolling ring is set by the system to achieve the pre-selected speed of travel.

The present invention is directed to a motion drive system for controlling a rolling ring drive.

Rolling ring drives are a common method of converting rotary motion to linear motion. Such drives are often used with regard to coiling wire and such like. The rolling ring drive proceeds in one direction where upon its direction of travel is reversed by flipping the rings contained within the rolling ring drive. Previously such reversal mechanisms have been entirely mechanical and the reversal of rings has been achieved by a lever attached to the reversal mechanism hitting a stop and the direction of travel of the drive thereby reversing as the rolling rings inside are rotated by spring-loaded mechanical mechanism. This has had the problem that considerable shock is introduced into the drive by this mechanical reversal. Such a rolling ring drive has been previously proposed in WO2014128302 of the Applicants the contents of which are imported in totality.

It is an aim of the present invention to provide system to driving such a rolling ring drive reducing shock and wear on the system.

Accordingly the present invention is directed to a motion drive system for controlling a rolling ring drive which comprises the steps of:

a determining the dead centre of the rolling rings to provide the operational mid-point for a stepper motor when reversing the rolling rings;

b establishing a start point:

c setting a first reversal point and a second point for reversal of the rolling ring drive which are defined in relation to the start point;

d determining the speed of travel of the rolling ring drive in dependence upon the material to be wound and/or the speed of the coiling;

e determining an end point for coiling depending upon the depth of coiling required or the amount of material to be coiled;

f from these, the pitch of the rolling ring is set by the system to achieve the pre-selected speed of travel.

This provides the advantage that the system can determine the parameters to control the drive reducing the wear on the system and taking into account at all stages the differential parameters of different drives either due to wear due to different factory tolerances. This thus enables the commissioning of the drive system to be achieved considerably quicker.

Preferably the system includes the additional step of:

g determining the edges of an angled spool such that the four points of the spool are input.

This provides the advantage of the even laying of material onto an angled spool and enables the adjustment of the travel to take this into account thus ensuring a good quality of winding is achieved.

In a preferred embodiment the system includes the step of: ensuring that the speed on the outbound and return leg of the travel of the rolling ring drive is different. This enables the different conditions of winding and or state of the drive to be taken into account. Therefore the system allows significantly more control over the mechanism to ensure smooth running of any winding process.

An example of a motion drive system reversal mechanism for a rolling ring drive will now be discussed in conjunction with the attached drawings in which:

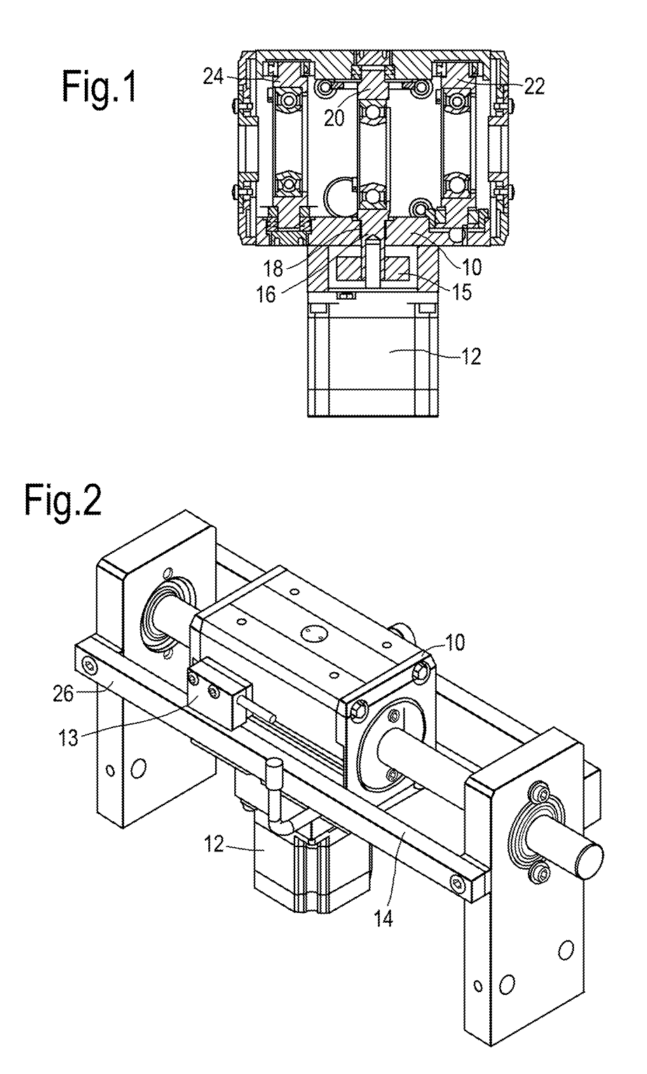

FIG. 1 shows a cross-section through a rolling ring drive;

FIG. 2 shows a side perspective view of a rolling ring drive fitted to a rotating shaft with a measuring system attached;

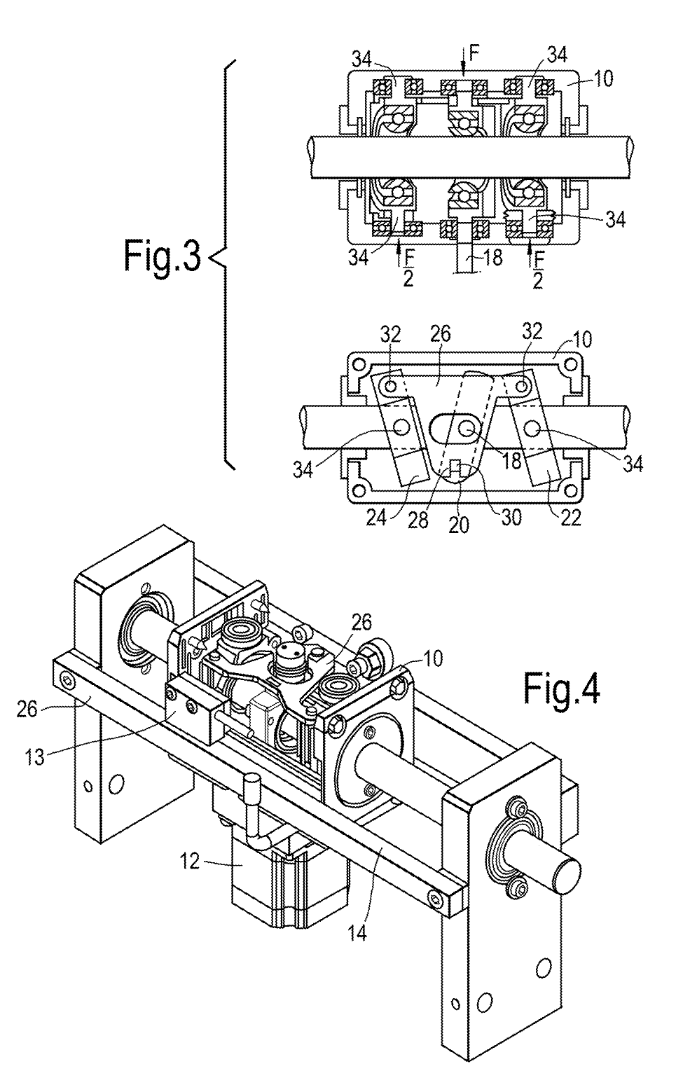

FIG. 3 shows a cross-section through the rolling ring drive equivalent to that shown in FIG. 1, below it is shown a plan view of the rolling ring drive taken from the side opposite the motor with the cover removed;

FIG. 4 shows the perspective view shown in FIG. 4 where the cover of the rolling ring drive has been removed;

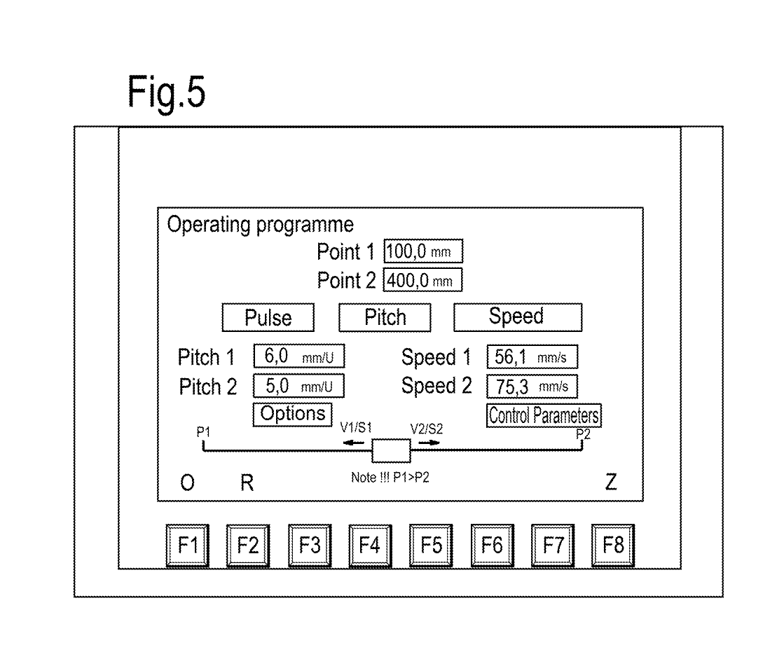

FIG. 5 shows a screenshot of an operating program page for a motion drive system;

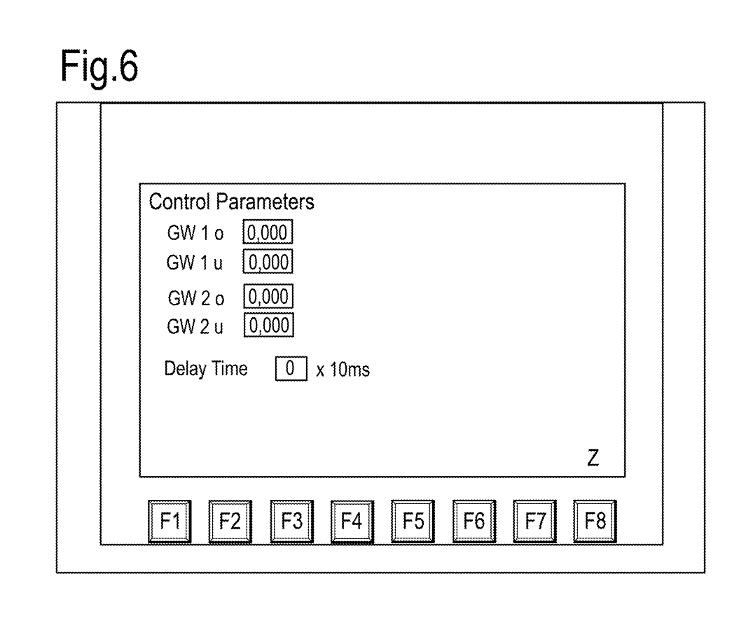

FIG. 6 shows a screenshot of a control parameter program page for a motion drive system;

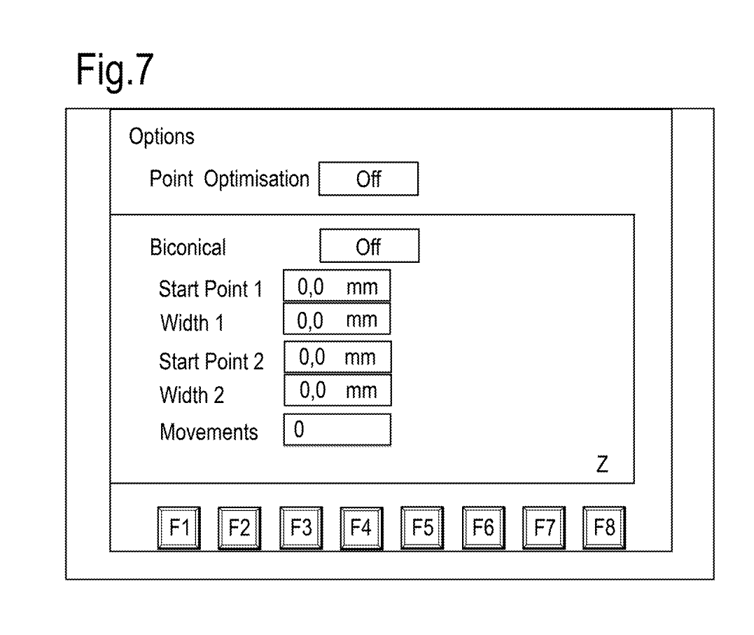

FIG. 7 shows a screenshot of an options page for a motion drive system;

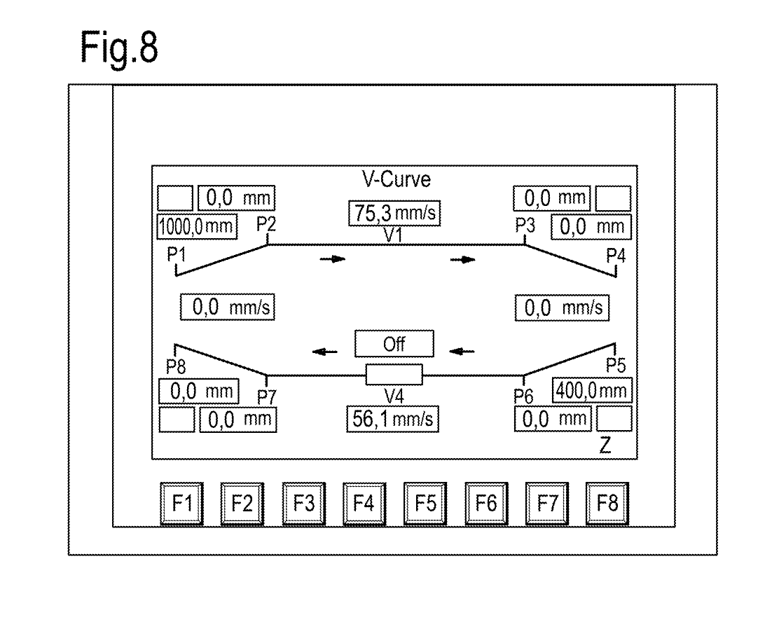

FIG. 8 shows a screenshot of a control screen for spool with angled edges;

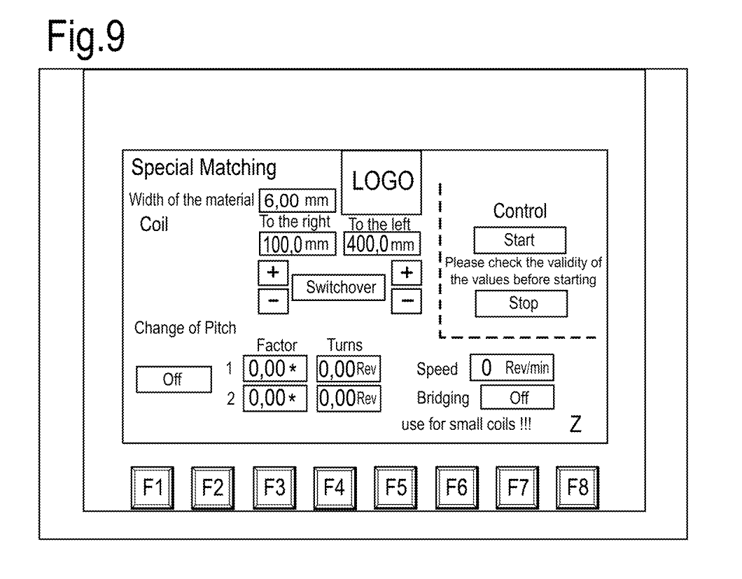

FIG. 9 shows a screenshot of a special set-up page for a motion drive system;

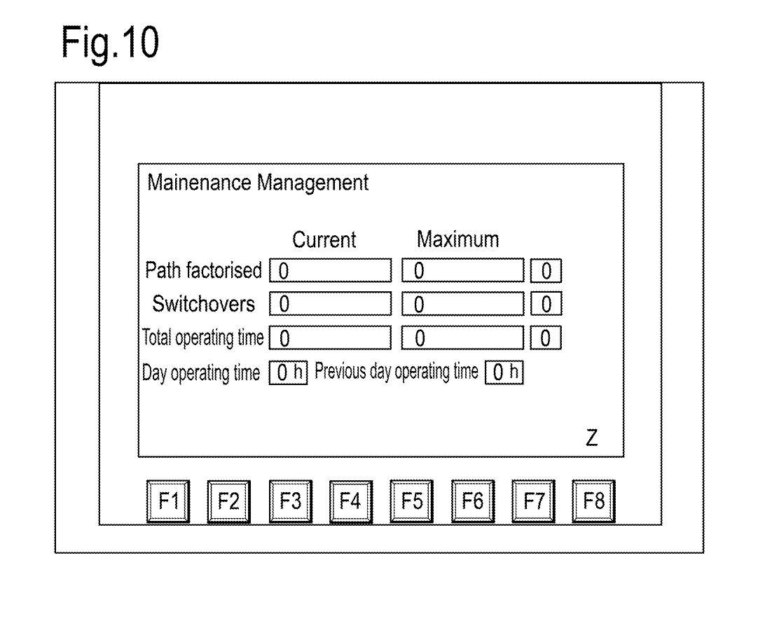

FIG. 10 shows a screenshot of a maintenance management page for a motion drive system;

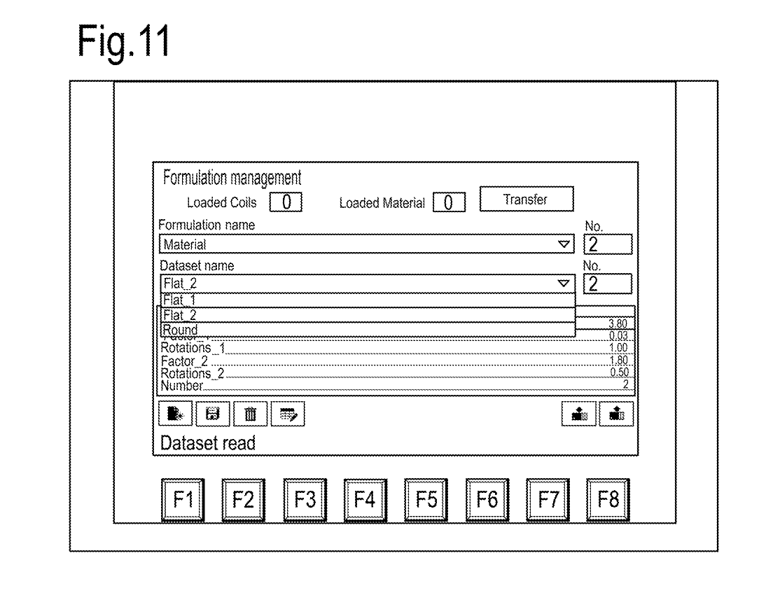

FIG. 11 shows a screenshot of a formulation management page for a motion drive system; and

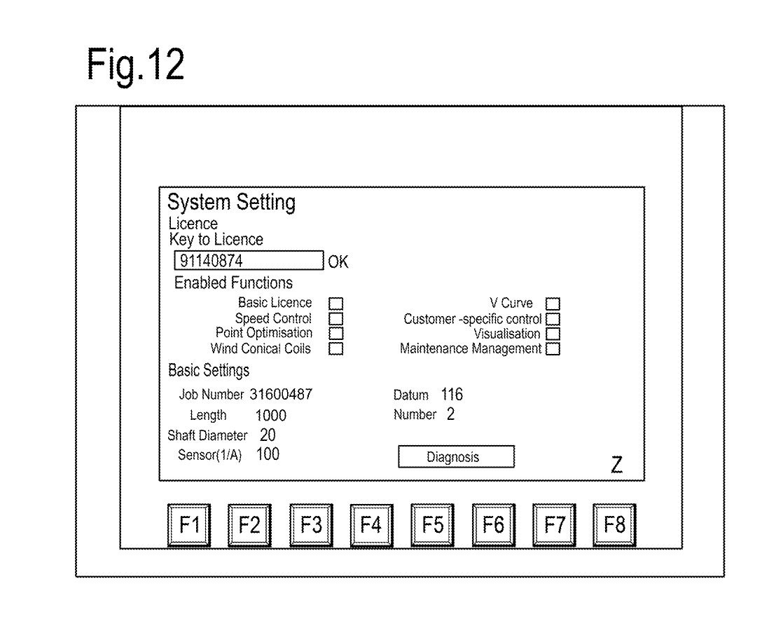

FIG. 12 shows a screenshot of a system setting page for a motion drive system.

Rolling ring drives are an adhesion transmission drive, which converts the rotary movement of a constantly rotating smooth shaft by means of rolling rings, which roll at an adjustable pitch angle on the shaft into a stroke movement. The rolling ring drive acts like nuts on screw spindles, but have a fine-pitch adjustment that can go to left or right and also be close to zero. The pitch is corrected by swiveling rolling rings, which roll their geometry and pressure at the shaft surface.

In FIG. 1 the stepper motor 12 is attached to the side of the rolling ring drive 10 instead a standard mechanical reversal system. The stepper motor 12 is connected to an inner ring housing 16 of the rolling ring drive 10 by a clamping ring 15. The clamping ring is attached to a shaft 18 which is attached to the central rolling ring 20. The central rolling ring 20 is mechanically connected to the other two rings 22 and 24. Thus when the shaft 18 is rotated the pitch of all the rings is altered accordingly.

FIG. 2 shows the position control of the rolling ring drive 10. A magnetic incremental measuring system 25 is attached to the side of the rolling ring drive each. The magnetic incremental measuring system 26 comprises a scanning head 13 attached to the side of the rolling ring drive 10, which runs during the stroke over a magnetic strip 14 attached to the outside of the track of the rolling ring drive 10. Thus detecting the portion of the drive and via a control altering the position of the rolling ring drives 22, 24 and 26 via the stepper motor 12.

FIG. 3 shows a cross-section through the rolling ring drive as shown in FIG. 1 in which the journals 34 about which the two outer drives 22 and 24 rotate can be seen. The figure also shows a plan view taken from the top of the rolling ring drive which is opposite to the side on which the motor 12 is mounted. This shows a T-Shaped mechanical linkage 26 which is connected via a notch 28 on the bottom of the T and a protrusion 30 on the central rolling ring drive 20 to it. The mechanical linkage 26 connection has a hole through the centre of its T-Shape which is elongate and in which the journal 34 of the central rolling ring drive 20 passes. The two sides of the top of the T are attached to the rolling ring drives 22 and 24 by swivels 32. This means that when the central rolling ring drive is rotated via the motor 12 the other two ring drives 22 and 24 are moved by the mechanical linkage 26.

FIG. 4 shows a cross-section through the rolling ring drive, firstly as shown in FIG. 1 in which the journals 34 about which the two outer drives 22 and 24 rotate can easily be seen. The figure also shows a plan view taken from the top of the rolling ring drive which is opposite to the side on which the motor 12 is mounted can be seen. This shows a mechanical linkage 26 which is attached via a notch and a protrusion 30 to the central rolling ring drive 20. The connection has a hole through its central of its T-shape which is elongate and in which the journal 34 of the central rolling ring drive 20 fits. The two sides of the top of the T are attached to the rolling ring drives 22 and 24 by swivels 32. This means that when the central rolling ring drive is rotated via the motor the other two ring drives 22 and 24 are moved the mechanical linkage 26.

FIG. 4 shows FIG. 2 with the casing of the rolling ring drive 10 removed this clearly shows the relationship of the motor 12 on the rolling ring drive to be opposite to the mechanical connection 26.

This electronic reversal mechanism for rolling ring drive replaces the mechanical reversal system with a stepper motor reversal mechanism including a control system. In the standard mechanical reversal system the shifting process is triggered by a spring-actuated mechanism, which acts upon contact fixed stops. The key advantage of the present reversal mechanism over the standard mechanical reversal system is that during a stroke, the pitch value and the reversal point (changeover) of the rolling ring drive can be changed individually for special winding or traversing tasks. Winding and traversing tasks with variable parameters during a stroke can be achieved. Pitch value per shaft rotation and the switchover of the rolling ring drive can be changed individually by the step motor control. The exact position or the distance path of the rolling ring drive can be monitored by the controller through an incremental magnetic measure system, a cable sensor, or similar.

By using a stepper motor reversal mechanism you can run speed up and slow down ramps at constant shaft speed by simple pitch control during the stroke. It is also possible through the combination of stepper motor reversal mechanism and position detection of the rolling ring drive to wind several coils side by side to a drive, if the exact reversal points are stored in the controller.

A motion drive system for a rolling ring drive will now be described with reference to FIGS. 5 to 12 which comprise the screenshots of the various pages of the control program.

Before the parameters for a particular job are entered into the control system for the rolling ring drive conducts a standard calibration to ensure the proper functioning of the rest of the control system. The drive shaft is rotated at a set speed. This speed is selected such that it is not too fast as this would result in significant movement of the rolling ring drive. The dead centre of the rolling rings is then determined. The program checks the position of the rolling ring drive and determines if it is moving on the shaft. The program then alters the angles of the rings such that the movement is slowly reduced until the drive is stopped. Once the drive has been stopped for a sufficient time it is determined that the dead centre has been achieved. As an example a period of 550 ms is considered sufficient. This then serves as the reference point for the input of pitch into the system control. This has the advantage that it determines the dead centre of the each individual drive and also if this alters due to wear on the rings. This reduces the need for extensive optimisation in the factory of the rolling ring drive.

The control system then determines the starting point of the rolling ring drive. This is normally at one or other end of the shaft however the exact position may need to be determined depending upon the job considered such that at this point the rolling ring drive is clear of any working parts that need to be accessed for the changing of for instance spools and other equipment attached to the drive system.

FIG. 5 shows the start screen for a simple winding operation. Point 1 is the first reversal point and Point 2 is the second reversal point. On the screen these are shown as 100 mm and 400 mm. The program is then inputted with the desired speed the rolling ring drive will move along the shaft for a set shaft speed. This then determines the pitch of the rolling rings. The program allows for the pitch to be set alternatively. The pitch can also be altered based on observations by the sensor 13 of the speed. In the screen there are two pitches shown which relate to the different directions of travel. This is because depending upon the operations concerned the speed of travel in each direction is not necessarily desired to be the same. A pulse is generated by upon reaching Point 1 or Point 2 which causes switchover or reversal of the rings. The speed of the rolling ring drive is measured and adjusted to the parameters set. The screenshot allows entry to further screens which relate to control parameters and options.

FIG. 6 shows the control parameter page. This has set limits for the two speeds defined in FIG. 5. This is to ensure that the speed of the rolling ring drive is within a set parameter. GW 1 o is the upper limit and GW 1 u is the lower limit and the same applies to GW 2. If these parameters are exceeded manual attention is brought to the system. The delay time notes the time for which the speed control is not in use (Dead-Band-Time).

FIG. 7 shows the options page. First of all it allows the user to select point optimisation which is the calculation of the slippage while a change of the direction occurs. Therefore biconical parameters relate to the start points at which reversal of travel begins and the width to the distance over which reversal occurs. The number of movements determines the depth to which a properly wound material will reach on a spool.

FIG. 8 shows that the V-curve screen which deals with the reversal phase of the rolling ring drive. The points P1, P2, P3, and P4 are on the outward direction and the points P5, P6, P7, and P8 are on the return direction of travel of the rolling ring drive. The point P1 is at the start of travel, the point P2 is when the drive has accelerated to the desired speed, point P3 is at the point when deceleration starts and point P4 is when the drive has stopped. This is similar for points P5, P6, P7 and P8. The V1 relates to the speed on the outbound run and the V4 relates to the speed on the return run. This allows detailed control of the laying of coiled material on a spool with angled edges.

FIG. 9 shows additional special information that can be added. This includes the possibility of adding in the width of the material being spooled and the edges of the spool to left and right which can be adjusted for different spools. Similarly the pitch can be changed depending upon the number of turns necessary and the depth of winding required. Speed of the winding drum can also be entered. It can also be noted if there is bridging with regard to small coils this means that there are other parts between the rolling ring drive and the spool onto which the material is being wound. The screen also provides a start and a stop button for the operation of the drive.

The maintenance management screen is shown in FIG. 10. With this it can be set the actual numbers achieved and the maximum when maintenance should occur. So you can have the number of drums wound or number of passes of the drive, the total number of switchovers i.e. reversals and the total operating time. It can be noted the operating length operating time on that day and on the previous day. This will enable a user of the machine to keep accurate view of the wear being given to the rolling ring drive.

FIG. 11 shows the formulation management screen for the programme in this the number of loaded coils and those with material loaded on can be noted. The contents of this can be transferred to other management systems in the factory via the transfer button. The formulation name enables the type of material concerned to be selected and the number required. The dataset name enables the type of material to be stored in a database or to be retrieved from the database for future use by the user.

FIG. 12 shows the system settings page which enables a user to select various functions and this can be dependent upon the license given to the user. This will enable the user to have access to enabled functions which are listed below: basic license, speed control, point optimisation winding conical coils, V-curve, customer-specific control, visualisation, maintenance management. Below are given the basic settings which relate to the work being carried out namely: job number, the length of the drive shaft, the diameter of the drive shaft, the sensor being used, the date, the number and diagnosis to look at for faults.

1. A method for controlling a motion drive system of a coiling device comprising a rolling ring drive and comprising the steps of: determining the dead centre of the rolling rings to provide the operational mid-point for a stepper motor when reversing the rolling rings; establishing a start point; setting a first reversal point and a second point for reversal of the rolling ring drive which are defined in relation to the start point; determining the speed of travel of the rolling ring drive in dependence upon the material to be wound and/or the speed of coiling; determining an end point for coiling depending upon the depth of coiling required or the amount of material to be coiled; from these, the pitch of the rolling ring is set by the system to achieve the pre-selected speed of travel.

2. A method for controlling a motion drive system of a coiling device comprising a rolling ring drive according to claim 1 further comprising the step of: determining the edges of an angled spool such that four points of the spool are input.

3. A method for controlling a motion drive system of a coiling device comprising a rolling ring drive according to claim 1 further comprising the step of: ensuring that speeds on an outbound and a return leg of travel of the rolling ring drive are different.
